(19) United States
(12) Patent Application Publication
(10) Pub. No.: US 2010/0089640 A1
(43) Pub. Date: Apr. 15, 2010

(54) PLASTIC CABLE CLAMPS DESIGNS IN STEEL OUTLET BOXES

(75) Inventors: Mike DiLillo, Chambly (CA); Alain Michaud, Richelieu (CA)

Correspondence Address: HOFFMANN & BARON, LLP, 6900 JERICHO TURNPIKE, SYOSSET, NY, 11791, US

(73) Assignee: THOMAS & BETTS INTERNATIONAL, INC., Wilmington, DE (US)

(21) Appl. No.: 12/578,874

(22) Filed: Oct. 14, 2009

Related U.S. Application Data
(60) Provisional application No. 61/196,162, filed on Oct. 15, 2008.

(51) Int. Cl. H02G 3/18

(52) U.S. Cl. 174/661

(57) ABSTRACT

A cable clamp for securing a wire or cable in an electrical outlet box having an interior, an exterior and one or more openings therebetween is provided. The cable clamp includes a body and one or more retaining devices that define one or more apertures. The body is adapted to mount in one of the one or more openings in the electrical outlet box and each of the one or more apertures is adapted to provide a passage for a wire or cable between the interior and exterior of the electrical outlet box. The one or more retaining devices are connected to the body and each of the one or more retaining devices is adapted to secure a wire or cable in one of the one or more apertures.

This application claims priority from provisional application Ser. No. 61/196,162, filed on Oct. 15, 2008, which is incorporated herein in its entirety.

### FIELD OF THE INVENTION

The present invention is a cable clamp for securing cables and wires to an electrical enclosure. In particular, the invention relates to a flexible cable clamp that compressively engages cables and wires entering an electrical outlet box.

### BACKGROUND OF INVENTION

An electrical outlet box provides a termination point for wires carrying electrical current through buildings, houses, and other structures. Wiring entering an electrical outlet box is typically connected to an electrical device, such as a receptacle or switch, mounted within the box. The box is usually covered by a face plate having an opening that allows access to the receptacle or switch while preventing contact with the wires inside the box. Outlet boxes are often used in installations where the wires are located within a wall or ceiling. Alternatively, outlet boxes may be used in exposed-conduit wiring installations where they are mounted on the surface of a structure, such as a wall, column or ceiling.

Outlet boxes are available in a variety of configurations and sizes. The type of box selected depends on the specific requirements of the application. Outlet boxes typically include a plurality of openings which provide entry for the wires into the box. These openings are usually covered by removable portions called “knockouts,” which can be easily removed by the installer as required. With most electrical devices, the outlet box is spacious enough to accommodate a sufficient length of excess wiring so that a connected device can be removed from the outlet box and serviced without disconnecting the device from the wiring.

To install an electrical device in an outlet box, an installer pulls the end of electrical wires or cable, through a knockout opening in the box. A long enough length of wires is pulled through the knockout to allow the wires to be connected to the electrical device outside the outlet box, where the installer has more room to work. After the wires are connected to the electrical device, the device is secured in the outlet box. The outlet box is designed to have sufficient volume and depth so that the excess wires can be easily packed into the box.

In many cases, the person who runs the wires/cable into the outlet box is not the same person who installs the device. Therefore, the wires/cable may not immediately be connected to the electrical device. Even if there is no appreciable time interval in between the steps, it is easier for the installer if the wire(s)/cable is secured to the box. To facilitate the installation, a clamp is typically used to hold the wires/cable in place (i.e., in the outlet box) and thereby free the installer's hands for other tasks. The use of a clamp also allows the wires to be pulled through and held in the outlet box long before a device is connected.

Many of the prior art clamps used to retain wires/cables in steel outlet boxes require the installer to thread the wires through the clamp or require the clamp to be fastened to the box once the wires are installed. Typically, a screw is used to secure the clamp to the outlet box and, in a constricted work space, this can be cumbersome and require excessive installer dexterity. Therefore, it is desirable to provide a clamp for an electrical outlet box which can be quickly and easily removed and inserted and which allows easy installation of wires into an outlet box without the difficulties of the prior art devices.

Moreover, most steel outlet boxes that are currently available have all of the components made of steel. Wires or cables entering the box are typically clamped in place using a steel clamp and screw. Two of the objectives for the cable clamp design are low manufacturing cost and ease of use. However, in the highly competitive field of outlet box manufacture, these objectives have not been fully achieved. Moreover, the clamping systems currently used for metal electrical outlet boxes have several disadvantages. They typically require a tool to tighten the clamp against the wire or cable, which makes the installation more difficult and increases the installation time. They also use a screw to secure the clamp which increases the cost and makes the manufacture of the electrical box more complex and expensive since the box must include a threaded aperture for receiving the screw. Accordingly, there is a need for a less expensive clamp that is not made of metal and does not use a screw to attach it to the electrical box.

### SUMMARY OF THE INVENTION

In accordance with the present invention, a cable clamp for securing a wire or cable in an electrical outlet box having an interior, an exterior and one or more openings therebetween is provided. The cable clamp includes a body and one or more retaining devices that define one or more apertures. The body is adapted to mount in one of the one or more openings in the electrical outlet box and each of the one or more apertures is adapted to provide a passage for a wire or cable between the interior and exterior of the electrical outlet box. The one or more retaining devices are connected to the body and each of the one or more retaining devices is adapted to secure a wire or cable in one of the one or more apertures.

In a first embodiment of the cable clamp, each of the one or more retaining devices includes a pair of pivotably movable doors. The pivotably movable doors can be attached to hinges. In addition, each of the one or more apertures can have a pair of opposing sides and the pair of pivotably movable doors can be resiliently attached to the pair of opposing sides. The pivotably movable doors pivot into the electrical outlet box when a force is applied and pivot back into the one or more apertures when the force is released.

In a second embodiment of the cable clamp, each of the one or more retaining devices includes one or more flexible arcuate members in each of the one or more apertures. Each of the flexible arcuate members is adapted to move through the aperture into the interior of the box when a force is applied from the exterior of the box. The body can also include one or more substantially rigid bases located on the second, opposing side of the aperture. A wire or cable is secured in one of the apertures between the flexible arcuate member and the substantially rigid base. The cable clamp can also include an anchoring device that is adapted to secure the body in the opening in the electrical outlet box.

In a third embodiment of the cable clamp, each of the one or more retaining devices includes two opposing flexible members. Each flexible member has a first end, a second end and a stop. Each of the one or more apertures in the body can have a pair of opposing sides and the first ends of the two opposing flexible members are attached to the pair of opposing sides. The two opposing flexible members pivot into the interior of the electrical outlet box and the stops are adapted to resiliently oppose the movement of the flexible members into the interior. The second end of each of the two opposing flexible members can have a recessed center portion that is adapted to cooperatively receive the wire or cable.

In a fourth embodiment of the cable clamp, each of the one or more apertures has a first side and a second side and each of the retaining devices includes a pivotal door. The pivotal door has an interior side and an exterior side and is attached to the first side of each of the one or more apertures. A plurality of teeth is located on the second side of each of the one or more apertures. A compressible component is attached to the interior side of the pivotal door and is adapted to oppose the movement of the pivotal door into the interior of the electrical box.

In a fifth embodiment of the cable clamp, each of the one or more apertures has a first side and a second side and each of the retaining devices includes a pivotal door. The pivotal door has an interior side and an exterior side attached to the first side of each of the one or more apertures. A plurality of teeth is located on the second side of each of the one or more apertures. The pivotal door has a substantially flat portion and a flexible member, which extends from the interior side of the pivotal door. The flexible member is adapted to oppose the movement of the pivotal door into the interior of the electrical box.

In a sixth embodiment of the cable clamp, each of the one or more apertures has a first side and a second side and each of the one or more retaining devices includes a pair of inwardly biased opposing members having a first end and a second end. The first ends of the pair of inwardly biased opposing members are attached to the first and second sides of the aperture and the second ends are adapted to cooperatively secure the wire or cable. The second ends of the pair of inwardly biased opposing members can extend into the interior of the electrical outlet box and can compressively contact each other.

In a seventh embodiment of the cable clamp, each of the one or more retaining devices includes a port having a large aperture and a small aperture. The large aperture is connected to the small aperture. The large aperture is adapted to provide a passage for a wire or a cable between the exterior and the interior of the electrical outlet box. After the wire or cable passes through the large aperture it is moved into the small aperture, which is adapted to snugly receive the wire or cable and secure it in the port.

In an eighth embodiment of the cable clamp, each of the one or more apertures has a first side and a second side and each of the one or more retaining devices includes a pair of inwardly biased opposing members having a first end and a second end. The first ends of the pair of inwardly biased opposing members are attached to the first and second sides of the aperture and the second ends are arcuately shaped and adapted to cooperatively secure the wire or cable in the aperture. The second ends of the pair of inwardly biased opposing members can extend into the interior of the electrical outlet box and can compressively contact each other.

### BRIEF DESCRIPTION OF THE FIGURES

The preferred embodiments of the clamp for an outlet box of the present invention, as well as other objects, features and advantages of this invention, will be apparent from the accompanying drawings wherein:

FIG. 1 is a perspective view of the back wall and two end walls of an electrical box with a first embodiment of the clamp of the present invention in the end walls.

FIGS. 2A, B and C are perspective, side and end views, respectively, of a second embodiment of the clamp of the present invention in the end wall of an electrical outlet box.

FIGS. 3A, B and C are an end view and two side views, respectively, of a third embodiment of the clamp of the present invention showing a clamp with no wires, a single wire and two wires, respectively, in the end wall of an electrical outlet box.

FIGS. 4A, B and C are an end view and two side views, respectively, of a fourth embodiment of the clamp of the present invention showing a clamp with no wires, a single wire and two wires, respectively, in the end wall of an electrical outlet box.

FIGS. 5A, B and C are an end view and two side views, respectively, of a fifth embodiment of the clamp of the present invention showing a clamp with no wires, a single wire and two wires, respectively, in the end wall of an electrical outlet box.

FIG. 6 is a perspective view of the back wall and two end walls of an electrical box with a sixth embodiment of the clamp of the present invention in the end walls.

FIG. 7 is a perspective view of the back wall and two end walls of an electrical box with a seventh embodiment of the clamp of the present invention in the end walls.

FIGS. 8A, B and C are an exterior perspective, top and interior perspective views, respectively, of an eighth embodiment of the clamp of the present invention in the end wall of an electrical outlet box.

### DETAILED DESCRIPTION OF THE INVENTION

The present invention relates to cable clamps that fit in an opening in a steel electrical outlet box and retains wires that enter the box through the opening. The cable clamps can be made of plastic or metal or a combination of both materials. The cable clamps can have flexible or spring members that are used to secure wires or cables that enter outlet boxes through openings in one of the walls. The cable clamps fit into an opening in the outlet box and one or more flexible retaining members are attached to the sides of one or more apertures in the clamp. Wires or cables entering the outlet box are inserted through the aperture and are engaged by the flexible retaining members to secure them in place. For the present disclosure, the terms wire and cable are used interchangeably and the use of one term or the other is not intended to limit the scope of the invention in any way.

The cable clamps of the present invention can be quickly and easily attached to an opening in an electrical outlet or junction box. The clamps can be oriented as desired by the user. For example, the retaining devices can be vertically or horizontally disposed in relation to each other and the back wall of the box. In addition, the cable clamps have a low manufacturing cost and efficiently grip the wires or cables and tighten against them when a force is exerted to pull the wires or cables out of the box.

The scope of the present invention includes a variety of different embodiments of the cable clamp with different retaining devices. Preferably, each cable clamp includes two retaining devices but the invention is not limited to cable clamps having two retaining devices. The present invention is also intended to cover cable clamps having one retaining device as well as cable clamps having three or more retaining devices. Each retaining device is preferably formed by two retaining members that flexibly receive and secure a wire(s) or cable in an electrical box. In general, the common feature of the cable clamps of the present invention is that the flexible members resist removal of the wires/cable in a manner similar to a “Chinese finger grip,” i.e., the more force applied to pull the wires/cable out of the outlet box, the tighter the members grip the sides of the wires/cable.

The cable clamps include a body and one or more retaining devices attached to the sides of one or more apertures in the body. The body is adapted to mount in an opening in an electrical outlet box and the apertures are adapted to provide a passage for wires and/or cables between the interior and exterior of the electrical outlet box. The retaining devices secure the wires or cables in the apertures. The retaining devices can include a pair of pivotably movable or hinged doors, a flexible arcuate member, two opposing flexible members, a pivotal door with a compressible component and a plurality of teeth, a pivotal door with a flexible member and a plurality of teeth, a pair of inwardly biased opposing members, a port having a small aperture and a large aperture, or a pair of opposing flexible members with arcuate ends.

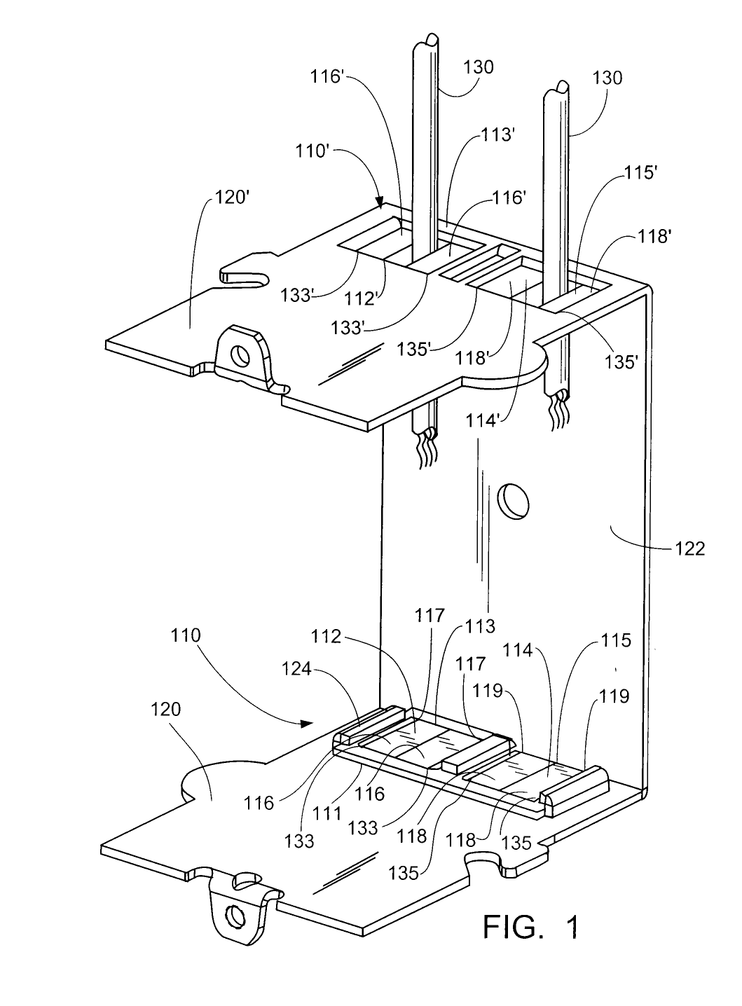

Referring now to the drawings, FIG. 1 shows a first embodiment of the cable clamp 110 installed in an electrical box (only the opposing end walls 120 and back wall 122 of the box are shown). The cable clamp 110 installed on one end wall 120 includes a body 111 with two apertures 113, 115 and two retaining devices 112, 114 located in the apertures 113, 115. Each retaining device 112, 114 has a pair of pivotably movable doors 116, 118 attached to hinges 117, 119 on the opposing sides 133, 135 of the apertures 113, 115.

FIG. 1 also shows a variation of the first embodiment of the cable clamp 110′ installed on the other end wall 120′, which includes a body 111′ with two apertures 113′, 115′ and two retaining devices 112′, 114′ located in the apertures 113′, 115′. The retaining devices 112′, 114′ include a pair of pivotably movable doors 116′, 118′ that are resiliently attached to the opposing sides 133′, 135′ of the apertures 113′, 115′.

The pivotably movable doors 116, 118 or 116′, 118′ pivot into the interior of the electrical outlet box when a force is applied from the exterior of the box and pivot back into the one or more apertures 113, 115 and 113′, 115′ when the force is released. When wires 130 enter the electrical box through either of the end walls 120, 120′, the pivotably movable doors 116, 118 or 116′, 118′ exert a compressive force against the wires 130 and secure them in place. Although FIG. 1 shows cable clamps 110, 110′ that have two retaining devices 112, 114 and 112′, 114′, respectively, for securing wires 130, the first embodiment (as well as the other embodiments) of the cable clamp is not limited to two retaining devices and can have one retaining device or three or more retaining devices.

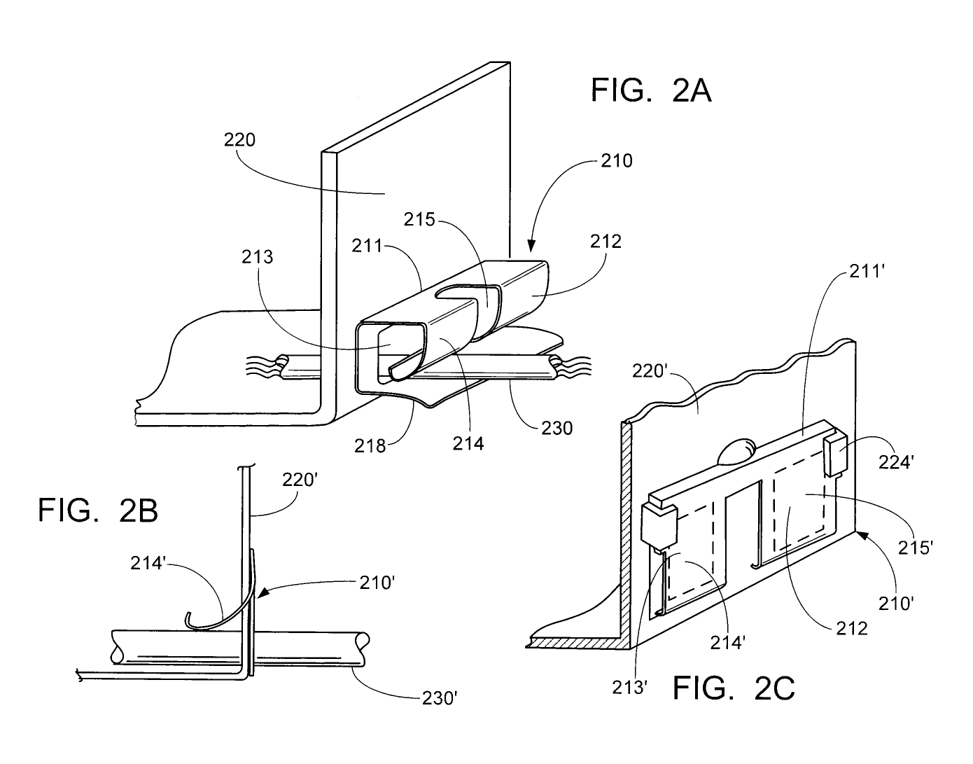

FIGS. 2A, B and C show two variations of a second embodiment of the cable clamp 210, 210′, which are preferably made of spring steel. FIG. 2A shows a variation of the second embodiment of the cable clamp 210 that includes a body 211 with two flexible arcuate members 212, 214 on the exterior of the end wall 220 of the electrical box. The cable clamp 210 is installed in the end wall 220 of an electrical outlet box and the two flexible arcuate members 212, 214 extend outwardly from the end wall 220 and then curve downwardly and inwardly. The flexible arcuate members 212, 214 define two apertures 213, 215 in the clamp 210 and each can independently secures a cable 230 in the box. Each of the flexible arcuate members 212, 214 is adapted to flex inwardly in the direction of (or into) the interior of the box when a force is applied from the exterior. The clamp 210 can also have a base 218 opposing the curved end of the flexible arcuate members 212, 214. After the wire 230 is inserted through the clamp 210, the flexible arcuate members 212, 214 press the wires 230 against the base 218 to secure them in place.

FIGS. 2B and 2C show another variation of the second embodiment of the cable clamp 210′ having two flexible arcuate members 212′, 214′ that are substantially flush with the end wall 220′ of the electrical box. The cable clamp 210′ is installed over at least one opening in the end wall 220′ and the two flexible arcuate members 212′, 214′ define two apertures 213′, 215′. When an electrical wire or cable 230′ is installed in the electrical box, one of the two flexible arcuate members 212′, 214′ is pushed inwardly through one of the apertures 213′, 215′ and into the interior of the electrical box. The cable clamp 210′ can also include an anchoring device 224′ that is adapted to secure the body 211′ to the end wall 220′ of the electrical outlet box.

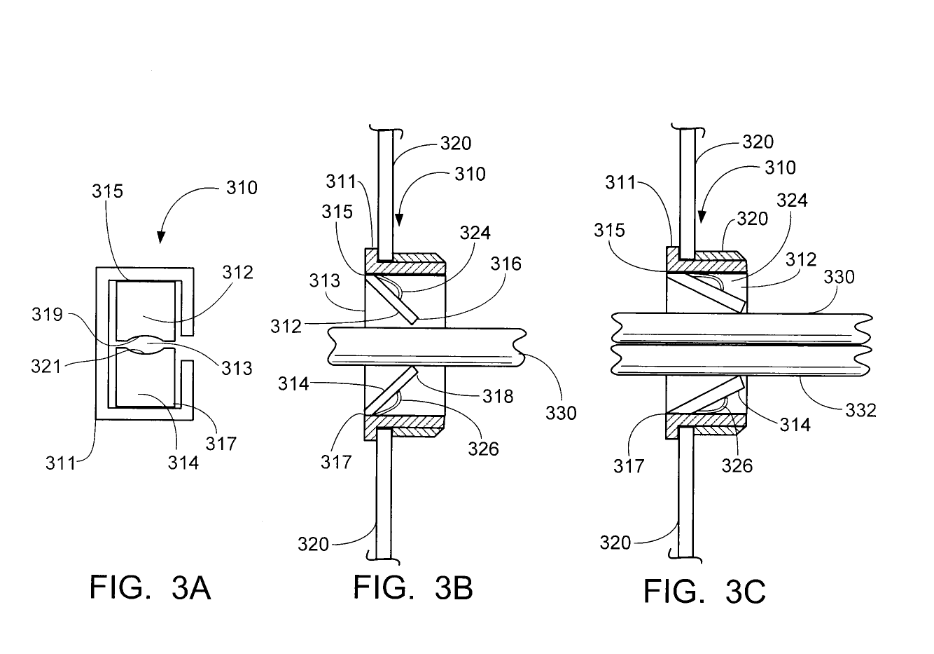

FIGS. 3A, B and C show a third embodiment of the cable clamp 310 which has a body 311 mounted in the end wall 320 of an electrical outlet box. The body 311 has an aperture 313 with two opposing sides 315, 317 and two opposing flexible members 312, 314 extending from the two opposing sides 315, 317 of the aperture 313. The two opposing flexible members 312, 314 is pivotably attached to the two opposing sides 315, 317 of the body 311 on one end and the unattached ends 316, 318 are aligned near the middle of the aperture 313. When a force is applied, the two opposing flexible members 312, 314 move from a closed position, wherein the two opposing flexible members 312, 314 restrict access to the interior of the electrical box, to an open position, wherein the two opposing flexible members 312, 314 pivotably rotate into the interior of the electrical box to allow the passage of one or more wires or cables 330, 332 into the box. The unattached ends 316, 318 of the two flexible members 312, 314 can have recessed edges 319, 321, respectively, that are adapted to cooperatively receive and secure the wires or cables 320, 322 (FIGS. 3B and C) in the box. After the wire(s) 320, (322) is inserted through the aperture 313 in the cable clamp 310, the flexible members 312, 314 press against the wire(s) 320, (322) to secure it in place. The flexible members 312, 314 can have resilient stops 324, 326 on the interior surfaces, which are adapted to resiliently oppose the movement of the flexible members 312, 314 into the interior of the box when a force is applied to install the wire(s) 320, (322) in the box.

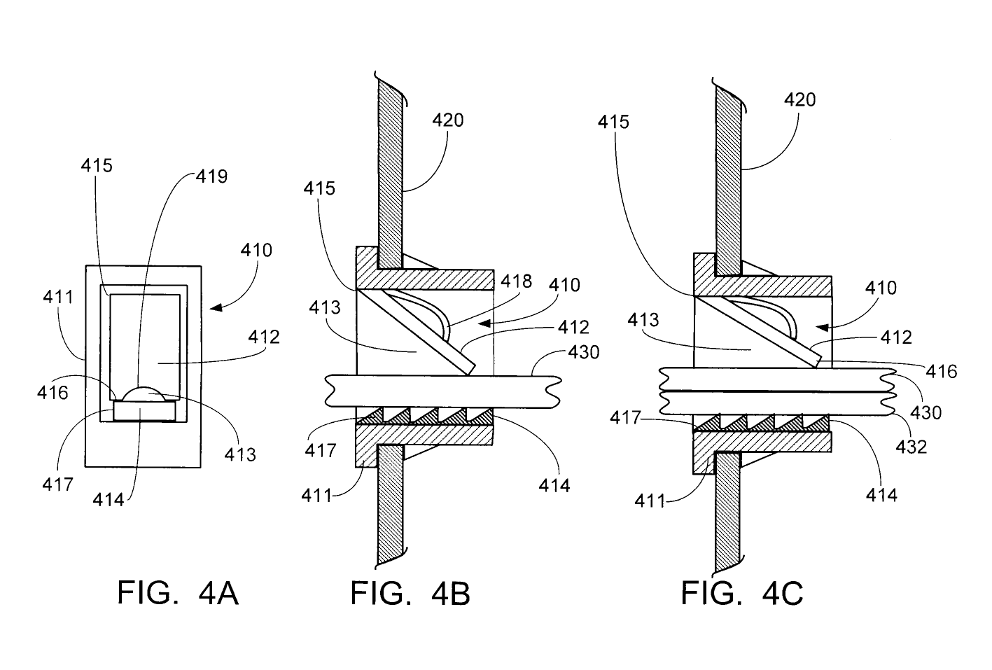

FIGS. 4A, B and C show a fourth embodiment of the cable clamp 410, which has a body 411 mounted in the end wall 420 of an electrical outlet box. The body 411 has an aperture 413 with two opposing sides 415, 417 and a pivotal door 412 attached to one opposing side 415 and a plurality of teeth 414 on the other opposing side 417. One or more wires or cables 430, 432 (FIGS. 4B and C) are inserted in the aperture 413 and secured in place between the pivotal door 412 and the plurality of teeth 414. After the wire(s) or cable(s) 430, 432 is inserted through the aperture 413 in the clamp 410, the pivotal door 412 presses against the wire(s) 430, 432 and the plurality of teeth 414 engage the wire(s) 430, 432 to secure it in place. The unattached end 416 of the pivotal door 412 can have a recessed edge 419 that is adapted to receive and secure the wires or cables 420, 422 (FIGS. 4B and C) in the box. The pivotal door 412 has a compressible component 418 attached to the interior side, which is adapted to oppose the movement of the pivotal door 412 into the interior of the electrical box when the pivotal door 412 flexes inwardly to receive the wire(s) 430, 432.

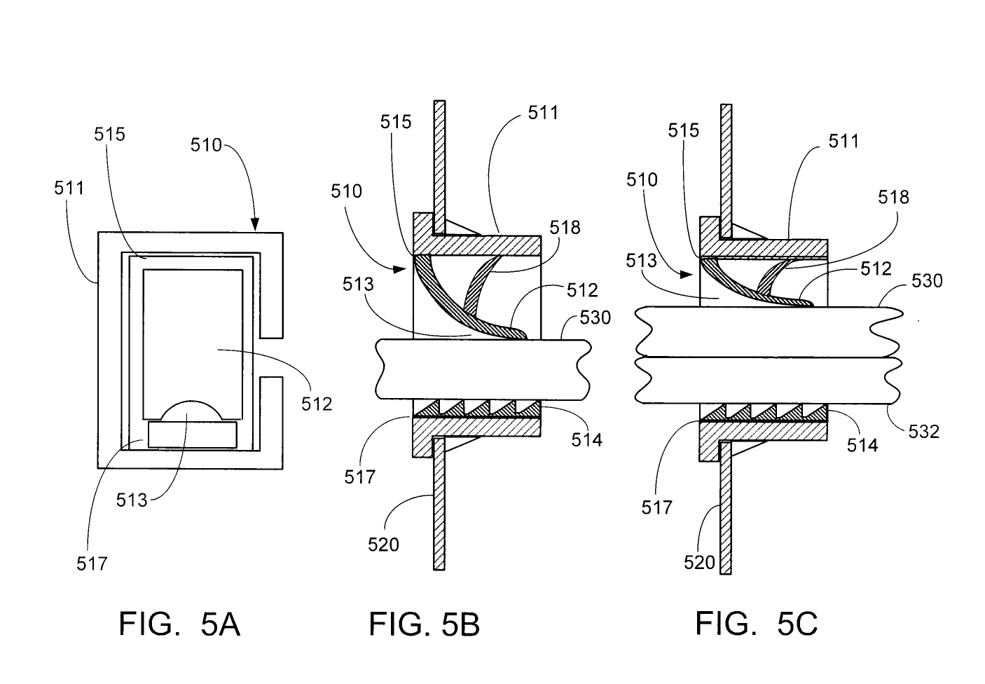

FIGS. 5A, B and C show a fifth embodiment of the cable clamp 510, which has a body 511 mounted in the end wall 520 of an electrical outlet box. The body 511 has an aperture 513 with two opposing sides 515, 517 and a pivotal door 512 with a flexible member 518 attached to one opposing side 515 and a plurality of teeth 514 on the other opposing side 517. One or more wires or cables 530, 532 (FIGS. 5B and C) are inserted in the aperture 513 and secured in place between the pivotal door 512 and the plurality of teeth 514. After the wire(s) or cable(s) 530, 532 is inserted through the aperture 513 in the clamp 510, the pivotal door 512 presses against the wire(s) 530, 532 and the plurality of teeth 514 engage the wire(s) 530, 532 to secure it in place. The flexible member 518 is attached to the interior side of the pivotal door 512 and is adapted to oppose the movement of the pivotal door 512 into the interior of the electrical box. When the pivotal door 512 flexes inwardly to receive the wire(s) 530, 532 the flexible member 518 exerts a force against the wire(s) 530, 532 to snugly retain them in the clamp 510.

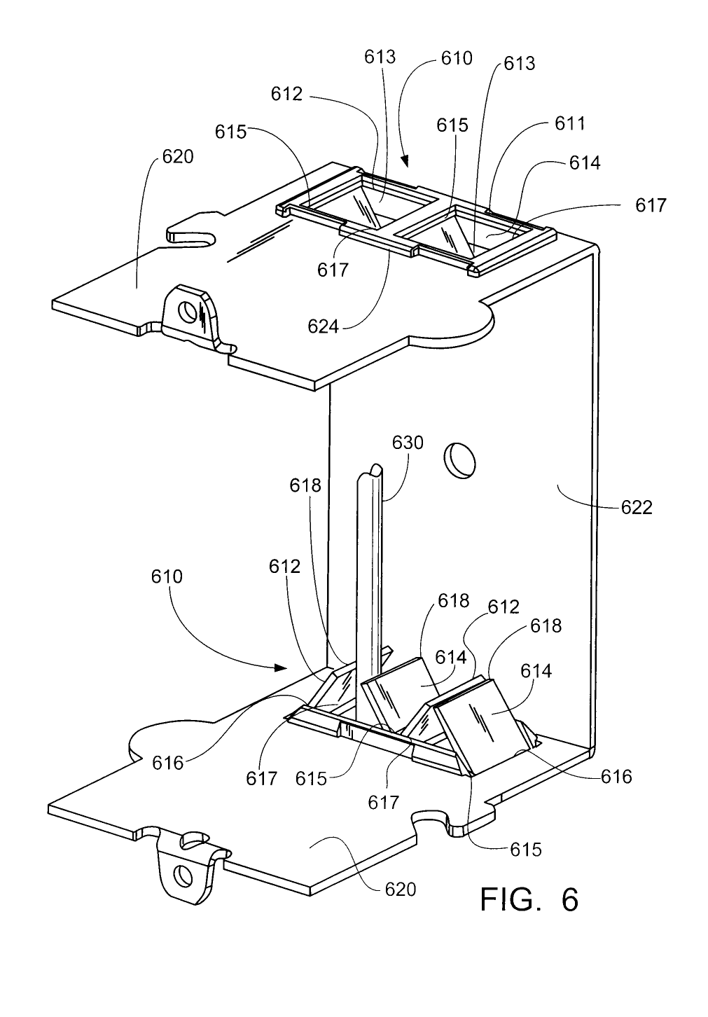

FIG. 6 shows a sixth embodiment of the cable clamp 610 mounted in the end walls 620 of an electrical box. The cable clamp 610 includes a body 611 with two apertures 613, wherein each aperture 613 has a pair of opposing sides 615, 617 and a pair of inwardly biased opposing members 612, 614. Each of the inwardly biased opposing members 612, 614 has first and second ends 616, 618, wherein the first end 616 is connected to one of the sides 615, 617 of one of the apertures 613 and the second ends 618 compressively contact each other. The inwardly biased opposing members 612, 614 extend into the interior of the electrical outlet box and move apart when a wire 630 is inserted through the aperture 613. After the wire 630 passes through the aperture 613, the inwardly biased opposing members 612, 614 cooperatively exert a compressive force against the wires and secure them in place. An anchoring device 624 can be used to retain the cable clamp 610 in the end wall 620 of the electrical box.

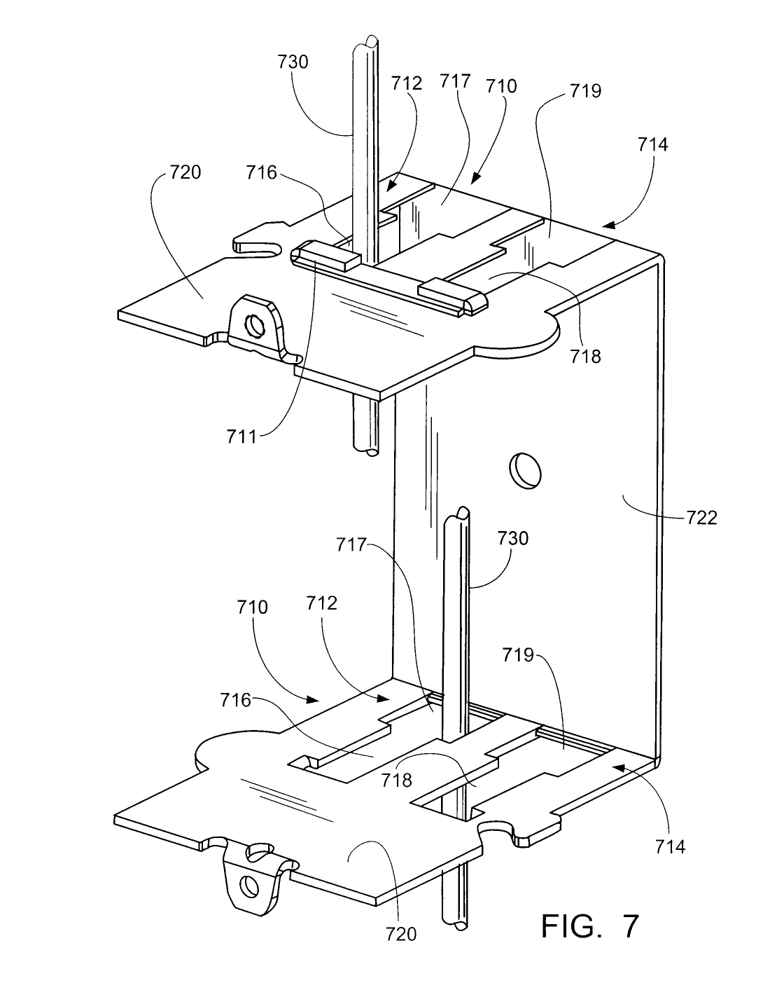

FIG. 7 shows a seventh embodiment of the clamp 710 mounted in the end wall 720 of an electrical box. The cable clamp includes a body 711 with two ports 712, 714 having a small aperture 716, 718 and a large aperture 717, 719. The wire or cable 730 entering the electrical box (the opposing end walls 720 and back wall 722 of the box are shown) are inserted through the large aperture 717, 719 of one of the ports 712, 714 and then moved into the small aperture 716, 718, which snugly engages the wire/cable 730 and secures it in place.

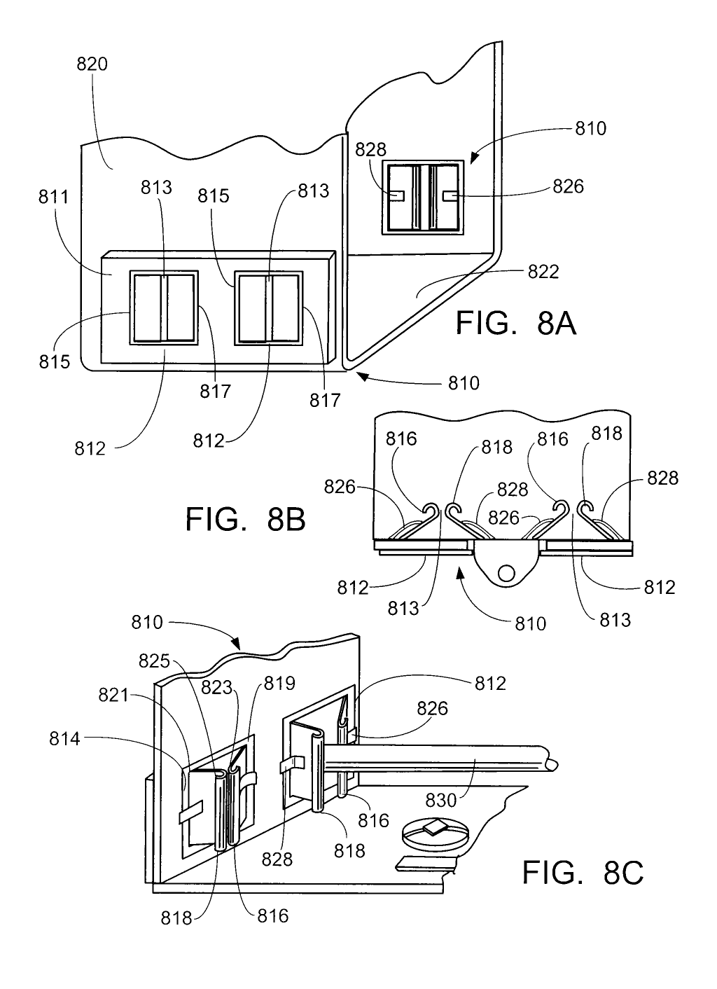

FIGS. 8A, B and C show an eighth embodiment of the clamp 810 in the end wall 820 of an electrical box. The clamp 810 includes a body 811 having two apertures 813 with a pair of opposing sides 815, 817. A retaining device 812 is formed in each aperture 813. The retaining device 812 includes a pair of biased flexible arcuate members 816, 818 having a first end 819, 821 and a second end 823, 825, respectively. The first end 819, 821 of each biased flexible arcuate members 816, 818 is attached to one of the opposing sides 815, 817 of the aperture 813 and the second ends 823, 825 extend into the interior of the box and curve away from each other. The flexible arcuate members 816, 818 are normally in a closed position and limit access to the electrical box through the apertures 813 in the retaining devices 813. The application of a force on the exterior of the flexible arcuate members 816, 818 pushes them into the interior of the electrical box and provides access through the apertures 813. The pair of biased flexible arcuate members 816, 818 act cooperatively to compressively secure a wire or cable 830 therebetween. The wire/cable 830 enters the electrical box (the opposing end walls 820 and back wall 822 of the box are shown) through one of the apertures 813 and the biased flexible arcuate members 816, 818 flex apart to receive the wire/cable 830. The biased flexible arcuate members 816, 818 exert a compressive force against the wire/cable 830 to secure it in place. The flexible arcuate members 816, 818 are provided with a flexible member 826, 828 that opposes the inward movement when a force is applied from the exterior. When the force is released, the flexible member 826, 828 force the flexible arcuate members 816, 818 towards each other.

Thus, while there have been described the preferred embodiments of the present invention, those skilled in the art will realize that other embodiments can be made without departing from the spirit of the invention, and it is intended to include all such further modifications and changes as come within the true scope of the claims set forth herein.

We claim:

1. A cable clamp for securing a wire or cable in an electrical outlet box having an interior, an exterior and one or more openings therebetween, the cable clamp comprising:
a body having one or more apertures, wherein the body is adapted to mount in one of the one or more openings in the electrical outlet box and each of the one or more apertures is adapted to provide a passage for a wire or cable between the interior and exterior of the electrical outlet box;
one or more retaining devices connected to the body,
wherein each retaining device is adapted to secure the wire or cable in one of the one or more apertures.

2. The cable clamp according to claim 1, wherein each of the one or more retaining devices comprises a pair of pivotably movable doors.

3. The cable clamp according to claim 2, wherein the pair of pivotably movable doors are attached to hinges.

4. The cable clamp according to claim 2, wherein each of the one or more apertures has a pair of opposing sides and the pair of pivotably movable doors is resiliently attached to the pair of opposing sides.

5. The cable clamp according to claim 2, wherein the pair of pivotably movable doors pivots into the electrical outlet box when a force is applied and pivots back into the one or more apertures when the force is released.

6. The cable clamp according to claim 1, wherein each of the one or more retaining devices comprises one or more flexible arcuate members in each of the one or more apertures, and wherein each of the flexible arcuate members is adapted to move through each of the one or more apertures into the interior of the box when a force is applied.

7. The cable clamp according to claim 6, wherein the body further comprises one or more substantially rigid bases located on the second opposing side, and wherein the wire or cable is secured between one of the one or more flexible arcuate members and one of the one or more substantially rigid bases.

8. The cable clamp according to claim 6 further comprising an anchoring device, wherein the anchoring device is adapted to secure the body in the opening in the electrical outlet box.

9. The cable clamp according to claim 1, wherein each of the one or more retaining devices comprises two opposing flexible members, wherein each flexible member has a first end, a second end and a stop.

10. The cable clamp according to claim 9, wherein each of the one or more apertures has a pair of opposing sides and the first ends of the two opposing flexible members are attached to the pair of opposing sides, and wherein the two opposing flexible members pivot into the interior of the electrical outlet box and the stops are adapted to resiliently oppose the movement of the flexible members into the interior.

11. The cable clamp according to claim 10, wherein the second end of each of the two opposing flexible members has a recessed center portion, and wherein the recessed center portion is adapted to cooperatively receive the wire or cable.

12. The cable clamp according to claim 1, wherein each of the one or more apertures has a first side and a second side, wherein each of the retaining devices comprises a pivotal door having an interior side and an exterior side attached to the first side and a plurality of teeth on the second side, and wherein a compressible component is attached to the interior side of the pivotal door.

13. The cable clamp according to claim 12, wherein the compressible component is adapted to oppose the movement of the pivotal door into the interior of the electrical box.

14. The cable clamp according to claim 1, wherein each of the one or more apertures has a first side and a second side, wherein each of the retaining devices comprises a pivotal door having an interior side and an exterior side, wherein each pivotal door is attached to the first side of the one or more apertures and a plurality of teeth are located on the second side of the one or more apertures, wherein the pivotal door has a substantially flat portion and a flexible member, wherein the flexible member extends from the interior side of the pivotal door.

15. The cable clamp according to claim 14, wherein the flexible member is adapted to oppose the movement of the pivotal door into the interior of the electrical box.

16. The cable clamp according to claim 1, wherein each of the one or more apertures has a first side and a second side, wherein each of the one or more retaining devices comprises a pair of inwardly biased opposing members having a first end and a second end, and wherein the first ends of the pair of inwardly biased opposing members are attached to the first and second sides of the aperture and the second ends are adapted to cooperatively secure the wire or cable.

17. The cable clamp according to claim 16, wherein the second ends of the pair of inwardly biased opposing members extend into the interior of the electrical outlet box.

18. The cable clamp according to claim 16, wherein the second ends of the pair of inwardly biased opposing members compressively contact each other.

19. The cable clamp according to claim 1, wherein each of the one or more retaining devices comprises a port having a large aperture and a small aperture, wherein the large aperture is connected to the small aperture, and wherein the large aperture is adapted to provide a passage for a wire or a cable between the exterior and the interior of the electrical outlet box and the small aperture is adapted to snugly receive the wire or cable and secure it in the port.

20. The cable clamp according to claim 1, wherein each of the one or more apertures has a first side and a second side, wherein each of the one or more retaining devices comprises a pair of inwardly biased opposing members having a first end and a second end, and wherein the first ends of the pair of inwardly biased opposing members are attached to the first and second sides of the aperture and the second ends are arcuately shaped and adapted to cooperatively secure the wire or cable.

21. The cable clamp according to claim 20, wherein the second ends of the pair of inwardly biased opposing members extend into the interior of the electrical outlet box.

22. The cable clamp according to claim 20, wherein the second ends of the pair of inwardly biased opposing members compressively contact each other.
